(19) United States
(12) Patent Application Publication
(10) Pub. No.: US 2025/0279107 A1
(43) Pub. Date: Sep. 4, 2025

(54) ASYMMETRIC AND ADAPTIVE STRENGTH FOR WINDOWING AT ENCODING AND DECODING TIME FOR AUDIO COMPRESSION

(71) Applicant: Google LLC, Mountain View, CA (US)

(72) Inventors: Jyrki Antero Alakuijala, Wollerau (CH); Sami Boukortt, Zurich (CH); Moritz Firsching, Basel (CH)

(21) Appl. No.: 18/858,879

(22) PCT Filed: May 17, 2022
(86) PCT No.: PCT/US2022/072376

§ 371 Date: Oct. 22, 2024

(51) Int. Cl. G10L 19/022; G10L 25/30; G10L 25/45

(52) U.S. Cl. CPC G10L 19/022; G10L 25/30; G10L 25/45

(57) ABSTRACT

A method including receiving a formatted data packet including a compressed frequency-domain audio signal and a power coefficient, decompressing the compressed frequency-domain audio signal, transforming the decompressed frequency-domain audio signal into a blocked time-domain audio signal, modifying an initial blocking window based on a power coefficient to generate a modified blocking window, and generating a reconstructed time-domain audio signal based on the blocked time-domain audio signal using the modified blocking window.

### FIELD

Embodiments relate to encoding and decoding audio.

### BACKGROUND

Communicating and/or storing audio signals is a common practice. For example, an audio signal can be streamed from a server to a user device so that a user may listen to replay of the audio signal. The audio signal can be streamed alone or together with a video stream. Audio signals can also be stored in storage media (e.g., fixed and/or portable computer memory) for later consumption.

### SUMMARY

Example implementations can enable improved compression by asymmetrically modifying a window (e.g., windowing function) associated with the audio encoder and/or the audio decoder.

In a general aspect, a device, a system, a non-transitory computer-readable medium (having stored thereon computer executable program code which can be executed on a computer system), and/or a method can perform a process with a method including receiving an initial time-domain audio signal, modifying an initial blocking window, based on a power coefficient, to generate a modified blocking window, generating a blocked time-domain audio signal using the modified blocking window, transforming the blocked time-domain audio signal to generate a frequency-domain audio signal, and compressing the frequency-domain audio signal to generate a compressed frequency-domain audio signal.

In another general aspect, a device, a system, a non-transitory computer-readable medium (having stored thereon computer executable program code which can be executed on a computer system), and/or a method can perform a process with a method including receiving a formatted data packet including a compressed frequency-domain audio signal and a power coefficient, decompressing the compressed frequency-domain audio signal, transforming the decompressed frequency-domain audio signal into a blocked time-domain audio signal, modifying an initial blocking window based on a power coefficient to generate a modified blocking window, and generating a reconstructed time-domain audio signal based on the blocked time-domain audio signal using the modified blocking window.

Implementations can include one or more of the following features. For example, the method can further include generating a data packet including the compressed frequency-domain audio signal and the power coefficient. The method can further include storing the compressed frequency-domain audio signal and the power coefficient. The method can further include playing back the reconstructed time-domain audio signal. The modified blocking window can be of an encoder, a decoder blocking window can be different from the modified blocking window, and a product of the modified blocking window with the decoder blocking window at an instance of the modified blocking window is equal to an amplitude of one (1). The modifying of the initial blocking window to generate the modified blocking window can be (2−pf)*f(t) where pf represents the power coefficient and f(t) represents the initial blocking window. The initial blocking window can include a first portion, a second portion and a third portion, and modifying the initial blocking window to generate the modified blocking window can include modifying the first portion based on the power coefficient and modifying the third portion based on the power coefficient.

The power coefficient can be generated based on the initial time-domain audio signal. The power coefficient can be generated based on an entropy associated with the compressing of the frequency-domain audio signal. The power coefficient can be generated based on the initial time-domain audio signal, and the power coefficient can be modified based on an entropy associated with the compressing of the frequency-domain audio signal. The initial time-domain audio signal can be associated with a first timespan, the method can further include detecting a change in the initial time-domain audio signal from the first timespan to a second timespan and changing the power coefficient based on the second timespan. The blocked time-domain audio signal can be a portion of the initial time-domain audio signal over a timespan equal to a timespan associated with the modified blocking window. The frequency-domain audio signal can include a frequency content representation of the blocked time-domain audio signal.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates an audio encoder/decoder signal flow diagram according to an example implementation.

FIG. 2 illustrates a signal flow diagram for generating a power factor according to an example implementation.

FIG. 3 illustrates a blocking window signal diagram according to an example implementation.

FIG. 4A illustrates a block diagram of an audio encoder according to an example implementation.

FIG. 4B illustrates a block diagram of an audio decoder according to an example implementation.

FIG. 5 illustrates a method of generating a formatted data packet according to an example implementation.

FIG. 6 illustrates a method of generating an audio signal according to an example implementation.

FIG. 7 shows an example of a computer device and a mobile computer device according to at least one example embodiment.

It should be noted that these Figures are intended to illustrate the general characteristics of methods and/or structure utilized in certain example embodiments and to supplement the written description provided below. These drawings are not, however, to scale and may not precisely reflect the precise structural or performance characteristics of any given embodiment and should not be interpreted as defining or limiting the range of values or properties encompassed by example embodiments. For example, the relative positioning of regions and/or structural elements may be reduced or exaggerated for clarity. The use of similar or identical reference numbers in the various drawings is intended to indicate the presence of a similar or identical element or feature.

### DETAILED DESCRIPTION

Audio signals are usually generated, at time of capture using a capture device (e.g., a microphone), as analog or time-domain audio signals. However, in order to be communicated and/or stored, the audio signals can, in many applications, be more efficiently stored (e.g., stored in a mobile device) and/or communicated (e.g., streamed to another device) when needs to be in a digital format (e.g., a MP3 format).

In order to digitally process (e.g., compressed, store in a memory, digitally communicate, stream, and/or the like) an audio signal (e.g., a time-domain audio signal), the audio signal can be processed into a block-based audio signal. A block-based audio signal can include samples (e.g., blocks) of the audio signal. The samples can be generated using time-domain windowing.

An input audio signal can be sampled in sequential temporal frames, each frame can include a portion of the input audio signal sampled within a sliding time window sometimes called temporal windowing. Temporal windowing can be used in, for example, block-based audio compression. The windowing (e.g., temporal windowing) can include implementing crossfading from a first (e.g., previous) block to a second (e.g., next) block. Crossfading can be used as a type of audio transition between two blocks. For example, a first block's audio fades down (e.g., is attenuated) while the second block's audio simultaneously fades up (e.g., is strengthened). During the crossfade, audio from both blocks is present (e.g., during playback both would be heard by a user). In some implementations, crossfading can be implemented in temporal windowing. For example, an amplitude of a first window decreases (e.g., fades down) while the amplitude of a second window simultaneously increases (e.g., fades up). Using the windowing/crossfade can allow for seamless movement from one block to the next without perceptible clicks at the block boundaries.

Unlike other (e.g., video and image) compression and decompression processes where a decoding can be approximately the opposite of encoding, windowing in the audio decoding function may not be the opposite of windowing in the audio encoding function. Instead, audio encoders and decoders may use the same windowing function. In an audio compression and decompression scheme, the energy of an audio stream that is input to the encoder should be equal to the energy of an audio stream that is output of the decoder. For energy to be preserved, the following function should be preserved for each processed (e.g., encoded and decoded) audio sample:

(Current block encoding windowing value+Next block encoding windowing value)*(Current block decoding windowing value+Next block decoding windowing value)

Therefore, traditional codecs apply the windowing function twice. Accordingly, a squared function can be the function that affects block crossfading. However, the encoding time windowing function can remove information when transients exist at or close to the edges of the blocks. For example, the amplitude of an audio impulse at the edge of a block (e.g., at a time when a temporal window begins or ends) can be reduced due to crossfading. Therefore, the resulting block can be codified with less bits. In addition, when a block contains harmonic content, the windowing function can introduce entropy (e.g., repetition that can be further compressed). Therefore, the resulting block can be codified with less bits. Accordingly, existing codecs may not compress an audio signal as efficiently (e.g., with the fewest bits) based on characteristics of the audio signal together with the characteristics of the windowing function.

Example implementations can enable improved compression by modifying the window (e.g., window function) associated with the audio encoder and/or the audio decoder. Example implementations can enable improved compression by using a power coefficient parameter that is used by the audio encoder, communicated in the compressed audio stream and used by the audio decoder. The audio signal can be encoded using a window function defined as, for example:

window*(2−power coefficient parameter),
and decoded using a window function defined as, for example:

window*(power coefficient parameter),
where window is the codec windowing function.

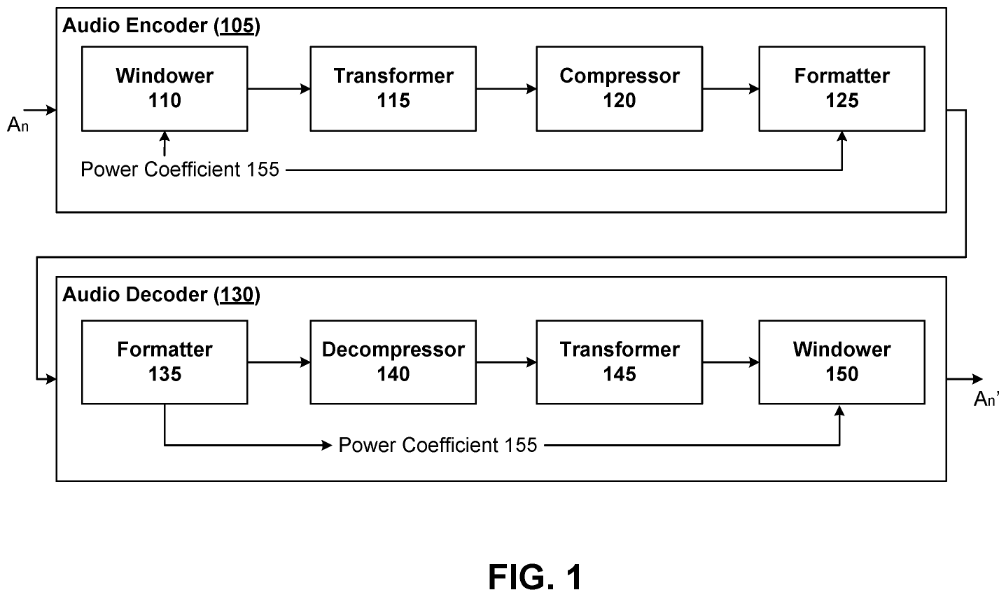

FIG. 1 illustrates an audio encoder/decoder signal flow diagram according to an example implementation. As shown in FIG. 1, the audio encoder/decoder signal flow includes an audio encoder 105 block and an audio decoder 130 block. The audio encoder 105 includes a windower 110 block, a transformer 115 block, a compressor 120 block, and a format 125 block. The audio decoder 130 includes a format 135 block, a decompressor 140 block, a transformer 145 block, and a windower 150 block.

The audio encoder 105 can be configured to compress an input audio signal Aₙ. The input audio signal Aₙ can be a time-domain audio signal. Compressing the audio signal can include converting the input audio signal Aₙ as an analog (e.g., continuous, infinitely variable, time-domain) signal to a digital (e.g., discrete-time, discrete-amplitude, frequency-domain) audio signal. Therefore, compressing the audio signal can include windowing (e.g., temporal windowing) and transforming (e.g., analog-to-digital) the input audio signal Aₙ.

The windower 110 can be configured to sample the input audio signal Aₙ in sequential temporal frames, each frame can include a portion of the input audio signal Aₙ sampled within a sliding time window sometimes called temporal windowing. In other words, the windower 110 can be configured to generate a block-based audio signal based on the input audio signal Aₙ. Therefore, the windower 110 can be referred to as a blocking window.

The blocking window can have a windowing function as defined by an audio codec. In an example implementation, the blocking window (e.g., windowing function) can be modified based on a power coefficient 155 to generate a modified blocking window. In an example implementation, the power coefficient 155 can be generated based on the input audio signal Aₙ. In an example implementation, the power coefficient 155 can be generated based on an entropy associated with compressing a frequency-domain audio signal that is generated by the transformer 115. In an example implementation, the power coefficient 155 can be generated based on the input audio signal Aₙ and the entropy associated with compressing the frequency-domain audio signal. In an example implementation, the power coefficient 155 can be further generated based on a timespan of the input audio signal Aₙ. In an example implementation, the power coefficient 155 can be further generated or changed based on a change in the timespan of the input audio signal Aₙ.

The transformer 115 can be configured to generate a frequency-domain audio signal based on the windowed input audio signal Aₙ. The transformer 115 can include an analog-to-digital converter (ADC). The ADC can use a Fourier transform (e.g., DCT, DFT, FFT). The ADC can be defined by an audio codec. For example, the ADC can be a direct ADC, a successive approximation ADC, a sigma-delta ADC, a pipelined ADC, a ramp-compare ADC, a Wilkinson ADC, an integrating ADC, and the like to name a few. The windower 110 and the transformer 115 can be combined to form the ADC. Often the ADC has an associated bandwidth (or configurable bandwidth). The band width can be the number of times per second the input audio signal Aₙ (e.g., analog source) is sampled by the windower 110 to generate discrete digital (or frequency-domain) values by the transformer 115.

The compressor 120 can be configured to compress (e.g., reduce the number of bits that represent) the digital (or frequency-domain) audio signal generated by the transformer 115. The compressor 120 can be configured to quantize and entropy encode the digital audio signal generated by the transformer 115. Quantization can reduce the data in each block (or frame as discussed above) of the digital audio signal. Quantization may involve mapping values within a relatively large range to values in a relatively small range, thus reducing the amount of data needed to represent each quantized block of the digital audio signal. The quantization may convert each block of the digital audio signal into discrete quantum values, which are referred to as quantized coefficients or quantization levels. For example, the quantization may be configured to add zeros to the data associated with a block of the digital audio signal. For example, a codec or encoding standard may define 128 quantization levels in a scalar quantization process.

Entropy encoding the digital audio signal the quantized digital audio signal can include creating and assigning a unique prefix-free code to each unique quantized coefficient or quantization level corresponding to the quantized digital audio signal. Entropy encoding can include compressing data by replacing each quantized coefficient or quantization level with the corresponding variable-length prefix-free output codeword to generate the compressed audio signal.

The format 125 can be configured to generate a formatted file including the compressed audio signal and the power coefficient 155 used by the windower 110. The formatted file can be formatted based on the codec. For example, the formatted file can be formatted to the opus, mp3, ambisonic, advanced audio coding (AAC), and the like audio file format.

The audio decoder 130 can be configured to generate a reconstructed audio signal Aₙ′. The reconstructed audio signal Aₙ′ can be an analog (or time-domain) audio signal. The format 135 can be configured to deconstruct the formatted file generated by the format 125. For example, the format 135 can be configured to extract the compressed audio signal and the power coefficient 155 from the formatted file generated by the format 125.

The decompressor 140 can be configured to perform the opposite operation of the compressor 120. In other words, the decompressor 140 can be configured to inverse entropy code and inverse quantize the compressed audio signal. The transformer 145 can be configured to perform the opposite operation (e.g., inverse discrete cosine transform (IDCT), inverse discrete Fourier transform (IDFT), inverse fast Fourier transform (IFFT)) of the transformer 115.

The windower 150 can be configured to combine adjacent blocks into a continuous output audio signal. The adjacent blocks can be overlap-added. In other words, transformed audio data blocks can be overlapped in time and concatenated together. The overlapped concatenated audio blocks can then be windowed. Overlapping and windowing the audio blocks can generate smooth transitions (e.g., transitions with minimal noise) between the audio blocks. Windowing can use a windowing function as defined by an audio codec. In an example implementation, the windowing function can be modified based on the power coefficient 155 extracted from the formatted file by the format 135. The windower 150 can generate the reconstructed audio signal Aₙ′ based on the overlap-added and windowed audio blocks.

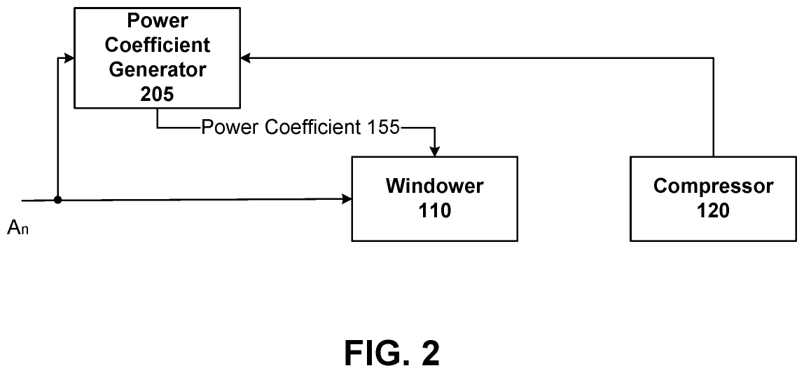

FIG. 2 illustrates a flow diagram for generating a power factor according to an example implementation. As shown in FIG. 2, the flow diagram includes the windower 110, the compressor 120 and a power coefficient generator 205. The power coefficient generator 205 can be configured to generate the power coefficient 155.

In an example implementation, the power coefficient generator 205 can be configured to generate the power coefficient 155 based on the input audio signal Aₙ. For example, the power coefficient generator 205 can be configured to determine characteristics of the input audio signal Aₙ and use a look-up-table to select the power coefficient 155 based on the characteristics of the input audio signal Aₙ. In an example implementation, the power coefficient generator 205 can be configured to us a machine learned model trained using training audio signals to predict the power coefficient 155 based on the input audio signal Aₙ. In an example implementation, the power coefficient generator 205 can be configured to determine characteristics of the input audio signal Aₙ and use data clustering to select the power coefficient 155 based on the characteristics of the input audio signal Aₙ. In an example implementation, an audio context model can be applied to the audio signal Aₙ and use the audio context model to select the power coefficient 155.

In an example implementation, the power coefficient generator 205 can be configured to generate the power coefficient 155 based on an entropy associated with compressing a frequency-domain audio signal that is generated by the transformer 115. For example, the associated with compressing the frequency-domain audio signal can be input to an entropy clustering model and use the entropy clustering model to select the power coefficient 155. In an example implementation, the power coefficient generator 205 can be configured to generate the power coefficient 155 based on the input audio signal Aₙ and the entropy associated with compressing the frequency-domain audio signal.

In addition to any of the abovementioned techniques used by the power coefficient generator 205 to generate the power coefficient 155, the power coefficient generator 205 can use information associated with the blocking window. For example. the power coefficient generator 205 can use a timespan of the blocking window, the ramp-up and/or ramp-down time, the slope of the ramp-up and/or ramp-down, an overlap of consecutive blocks, an overlap of two blocking windows, and/or the like. In an example implementation, the power coefficient generator 205 can be configured to further generate the power coefficient 155 based on a timespan of the type (e.g., constant, impulse, and/or the like) of the input audio signal Aₙ. In an example implementation, the power coefficient generator 205 can be configured to further generate or change the power coefficient 155 based on a change in the timespan of the input audio signal Aₙ and/or the timespan of the blocking window. For example, an initial blocking window could have a timespan of 20 ms and could switch to 2.5 ms if, for example, the input audio signal Aₙ includes a transient wide-spectrum sound. In a switch of window lengths, the overall overlap of encoder blocking window amplitude values multiplied with the decoder blocking window amplitude values should sum up to one (1.0), when contributions of consecutive windows are accounted for.

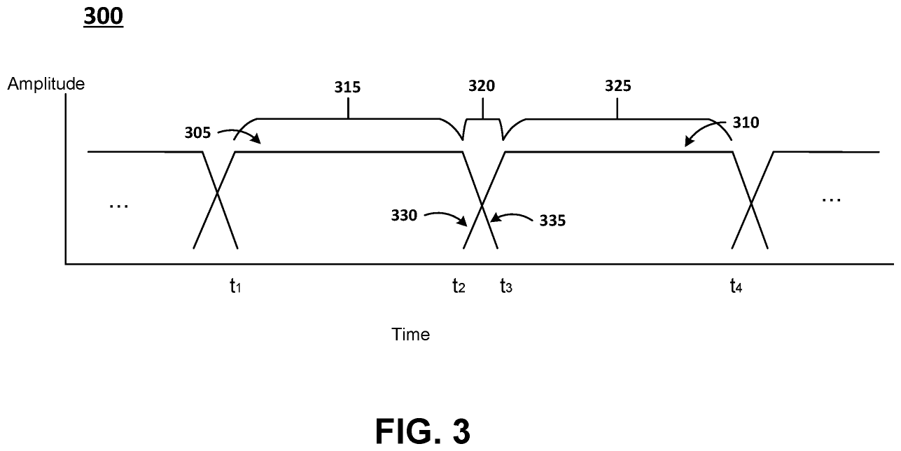

FIG. 3 illustrates a signal diagram including a blocking window according to an example implementation. As shown in FIG. 3, a signal diagram 300 can include a plurality of blocking windows. As an example, the signal diagram 300 includes a previous blocking window 305 and a current blocking window 310. The previous blocking window 305 and the current blocking window 310 can be defined by a windowing function. The windowing function can be based on a windowing function defined by a codec. In an example implementation, the windowing function can be further based on a power coefficient (e.g., power coefficient 155). The signal diagram 300 can be used for temporal windowing of an audio signal.

The signal diagram 300 can include a plurality of portions. For example, the signal diagram 300 can include a constant portion 315, 325 and a crossfading portion 320. The crossfading portion 320 can include an increasing (e.g., fade up) amplitude 330 of the current blocking window 310 and a simultaneous decreasing (e.g., fade down) amplitude 335 of the previous blocking window 305. Crossfading is a type of audio transition between two blocks. For example, a first block's audio fades down while the second block's audio simultaneously fades up.

During the crossfade, audio from both blocks is present (e.g., during playback both would be heard by a user). Crossfading can be implemented in temporal windowing. Using the windowing/crossfade can allow for seamless movement from one block to the next without perceptible clicks at the block boundaries. For example, as illustrated by signal diagram 300, from time t₁ to time t₂ an amplitude of constant portion 315 is constant which therefore generates a constant windowing of the audio signal from time t₁ to time t₂. By contrast, as illustrated by signal diagram 300, from time t₂ to time t₃ the amplitude 335 of blocking window 305 decreases and the amplitude 330 of blocking window 310 increases in order to implement crossfading (e.g., in crossfading portion 320) of the audio signal from time t₂ to time t₃. Then, as illustrated by signal diagram 300, from time t₃ to time t₄ an amplitude of constant portion 325 is constant which again generates a constant windowing of the audio signal from time t₃ to time t₄.

As mentioned above, conventional codecs use the same windowing function in the audio decoder as used in the audio encoder. However, in example implementations, the windowing function used in the audio decoder can be different as compared to the windowing function in the audio encoder. Accordingly, a block window in an example audio encoder and an example audio decoder can modify an initial blocking window (e.g., the blocking window defined by the codec) to generate a modified blocking window. In an example implementation, the modified blocking window generated and used by the audio encoder can be different than the modified blocking window generated and used by the audio decoder. For example, the modified blocking window generated and used by the audio encoder can be a windowing function defined as, for example:

A*window*(B−power coefficient parameter),
and decoded using a window function defined as, for example:

C*window*(D*power coefficient parameter),
where window is the codec windowing function, and
A, B, C and D are predetermined (e.g., at runtime or design time) constants.

As mentioned above, the modified blocking window generated and used by the audio encoder can be different than the modified blocking window generated and used by the audio decoder. For example, in the windowing function of the audio encoder A can equal one (1) and B can equal two (2) such that modifying the blocking window to generate the modified blocking window for the audio encoder is (2−pf)*f(t) where pf represents the power coefficient and f(t) represents the initial blocking window. In addition, in the windowing function of the audio decoder C can equal one (1) and D can equal one (1) such that modifying the blocking window to generate the modified blocking window for the audio decoder is (pf)*f(t) where pf represents the power coefficient and f(t) represents the initial blocking window.

In an example implementation, the constant portion 315, 325 and the crossfading portion 320 can be modified differently. For example, modifying the blocking window to generate the modified blocking window can include modifying the crossfading portion 320 based on the power coefficient and keeping the constant portion 315, 325 the same as defined by the codec or modifying the blocking window to generate the modified blocking window can include modifying the constant portion 315, 325 based on the power coefficient and keeping the crossfading portion 320 the same as defined by the codec. For example, the increasing amplitude 330 and/or the decreasing amplitude 335 and/or the amplitude of the constant portion 315, 325 can be modified based on the power coefficient. In other words, there can be, for example, three (3) power coefficients.

In an example implementation a multiplication, at each sample of the initial time-domain audio signal, when overlapped with consecutive instances of the modified blocking window, sum to an amplitude equal to one (1). A multiplication of the modified blocking window of the encoder and the decoder, at each sample of the initial time-domain audio signal, when overlapped with consecutive instances of the modified blocking window, sum to an amplitude equal to one (1). A product (e.g., multiplied product) of the modified blocking window with the encoder or decoder blocking window at overlapped consecutive instances of each sample of the initial time-domain audio signal is equal to an amplitude of one (1). A product (e.g., multiplied product) of the modified blocking window with the encoder or decoder blocking window at an instance of the modified blocking window is equal to an amplitude of one (1).

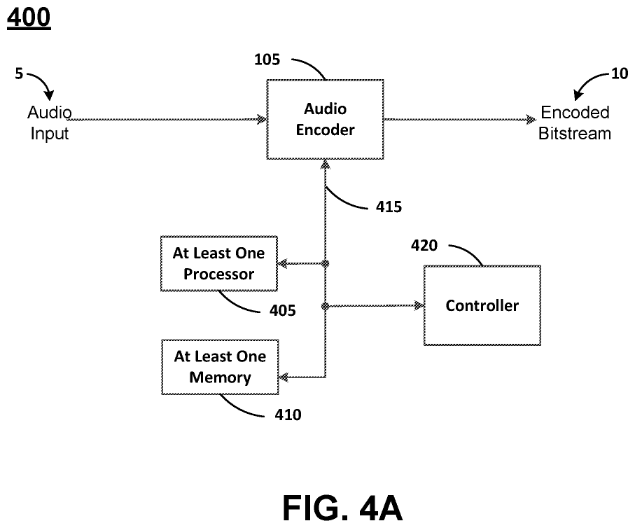

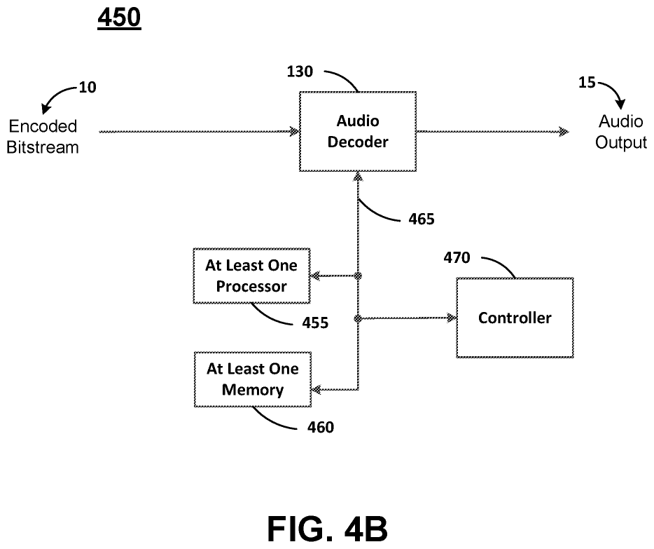

FIG. 4A illustrates a block diagram of an audio encoder according to an example implementation. In the example of FIG. 4A, an audio encoder system 400 may be at least one computing device and should be understood to represent virtually any computing device configured to perform the methods described herein. As such, the audio encoder system 400 may be understood to include various standard components which may be utilized to implement the techniques described herein, or different or future versions thereof.

FIG. 4A illustrates the audio encoder system 400 according to at least one example embodiment. As shown in FIG. 4A, the audio encoder system 400 includes the at least one processor 405, the at least one memory 410, a controller 420, and the audio encoder 105. The at least one processor 405, the at least one memory 410, the controller 420, and the audio encoder 105 are communicatively coupled via bus 415.

Thus, as may be appreciated, the at least one processor 405 may be utilized to execute instructions stored on the at least one memory 410, so as to thereby implement the various features and functions described herein, or additional or alternative features and functions. Of course, the at least one processor 405 and the at least one memory 410 may be utilized for various other purposes. In particular, the at least one memory 410 may be understood to represent an example of various types of memory and related hardware and software which might be used to implement any one of the modules described herein.

The at least one processor 405 may be configured to execute computer instructions associated with the controller 420 and/or the audio encoder 105. The at least one processor 405 may be a shared resource. For example, the encoder system 400 may be an element of a larger system (e.g., a streaming server). Therefore, the at least one processor 405 may be configured to execute computer instructions associated with other elements (e.g., a streaming server streaming audio) within the larger system.

The at least one memory 410 may be configured to store data and/or information associated with the encoder system 400. For example, the at least one memory 410 may be configured to store audio codecs. The controller 420 may be configured to generate various control signals and communicate the control signals to various blocks in encoder system 400. The controller 420 may be configured to generate the control signals in accordance with the techniques described above.

FIG. 4B illustrates a block diagram of an audio decoder according to an example implementation. In the example of FIG. 4B, an audio decoder system 450 may be at least one computing device and should be understood to represent virtually any computing device configured to perform the methods described herein. As such, the audio decoder system 450 may be understood to include various standard components which may be utilized to implement the techniques described herein, or different or future versions thereof. As shown in FIG. 4B, the audio decoder system 450 includes the at least one processor 455, the at least one memory 460, a controller 470, and the audio decoder 130. The at least one processor 455, the at least one memory 460, the controller 470, and the audio decoder 130 are communicatively coupled via bus 465.

The at least one processor 455 may be utilized to execute instructions stored on the at least one memory 460, so as to thereby implement the various features and functions described herein, or additional or alternative features and functions. Of course, the at least one processor 455 and the at least one memory 460 may be utilized for various other purposes. In particular, the at least one memory 460 may be understood to represent an example of various types of memory and related hardware and software which might be used to implement any one of the modules described herein. According to example embodiments, the audio encoder system 400 and the audio decoder system 450 may be included in a same larger system. Further, the at least one processor 405 and the at least one processor 455 may be a same at least one processor and the at least one memory 410 and the at least one memory 460 may be a same at least one memory. Still further, the controller 420 and the controller 470 may be a same controller.

The at least one processor 455 may be configured to execute computer instructions associated with the controller 470 and/or the audio decoder 130. The at least one processor 455 may be a shared resource. For example, the audio decoder system 450 may be an element of a larger system (e.g., a mobile device). Therefore, the at least one processor 455 may be configured to execute computer instructions associated with other elements (e.g., web browsing or wireless communication) within the larger system.

The at least one memory 460 may be configured to store data and/or information associated with the audio decoder system 450. The controller 470 may be configured to generate various control signals and communicate the control signals to various blocks in audio decoder system 450. The controller 470 may be configured to generate the control signals in accordance with the techniques described above.

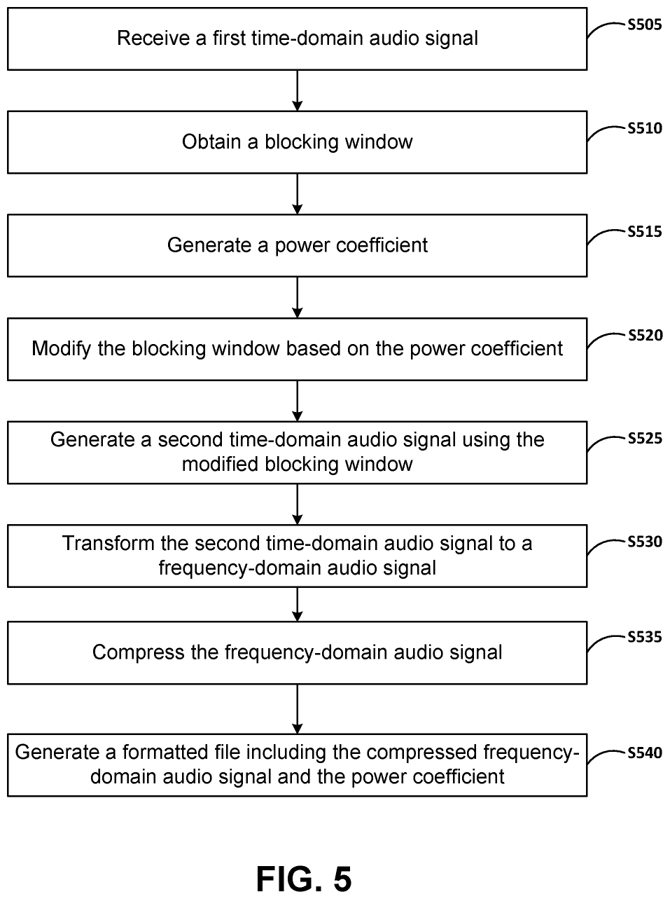

FIG. 5 illustrates a method of generating a formatted data packet according to an example implementation. As shown in FIG. 5, in step S505 a first time-domain audio signal is received. For example, an input audio signal can be an analog (e.g., continuous, infinitely variable) or time-domain audio signal. For example, music or speech can be captured as an analog audio signal by a microphone.

In step S510 a blocking window is obtained. For example, an audio compression/decompression codec (e.g., opus, mp3, ambisonic, AAC, ASF, and the like) can include a windowing function corresponding to the blocking window. Therefore, the blocking window can be obtained (e.g., read from memory) from the codec.

In step S515 a power coefficient is generated. In an example implementation, the power coefficient can be generated based on the input audio signal. In an example implementation, the power coefficient can be generated based on an entropy associated with compressing the input audio signal. In an example implementation, the power coefficient can be generated based on the input audio signal and the entropy associated with compressing the input audio signal. In an example implementation, the power coefficient can be further generated based on a timespan of the input audio signal. In an example implementation, the power coefficient can be further generated or changed based on a change in the timespan of the input audio signal.

In step S520 the blocking window is modified based on the power coefficient. For example, an initial blocking window can be modified based on the power coefficient to generate a modified blocking window. For example, an amplitude of a windowing function associated with the blocking window can be modified based on the power coefficient.

In step S525 a second time-domain audio signal is generated using the modified blocking window. For example, a blocked time-domain audio signal can be generated using the modified blocking window. The input audio signal can be sampled in sequential temporal frames, each frame can include a portion of the input audio signal sampled within a sliding time window sometimes called temporal windowing. In other words, the second time-domain audio signal can be generated as a block-based audio signal based on the input audio signal.

In step S530 the second time-domain audio signal is transformed to a frequency-domain audio signal. For example, the modified time-domain audio signal can be transformed to generate a frequency-domain audio signal. The transform can include applying an analog-to-digital converter (ADC) to the second time-domain audio signal or inputting the second time-domain audio signal to the ADC. The ADC can use a Fourier transform (e.g., DCT, DFT, FFT)

In step S535 the frequency-domain audio signal is compressed. For example, the frequency-domain audio signal can be compressed to generate a compressed frequency-domain audio signal. compression can include reducing the number of bits that represent the transformed frequency-domain audio signal. The compression can include quantizing and entropy encoding the transformed frequency-domain audio signal.

In step S540 a formatted file including the compressed frequency-domain audio signal and the power coefficient is generated. For example, the formatted file can be formatted based on the codec. For example, the formatted file can be formatted to the opus, mp3, ambisonic, AAC, ASF, and the like audio file format. The formatted file can include the compressed frequency-domain audio signal and the power coefficient.

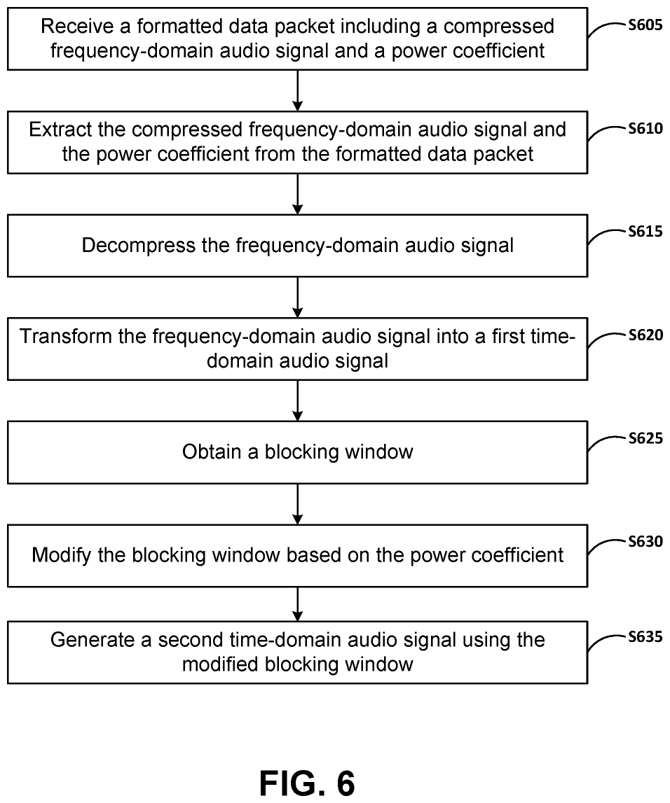

FIG. 6 illustrates a method of generating an audio signal according to an example implementation. As shown in FIG. 6, in step S605 a formatted data packet including a compressed frequency-domain audio signal and a power coefficient is received. For example, the formatted file can be formatted based on the codec. For example, the formatted file can be formatted to the opus, mp3, ambisonic, AAC, ASF, and the like audio file format. The formatted file can include the compressed frequency-domain audio signal and the power coefficient.

In step S610 the compressed frequency-domain audio signal and the power coefficient are extracted from the formatted data packet. For example, the formatted file can be stored in a memory of the receiving device. The frequency-domain audio signal and the power coefficient can be read from the memory location.

In step S615 the frequency-domain audio signal is decompressed. For example, the opposite operation of the compression by the encoder can be performed. In other words, an inverse entropy and inverse quantization can be performed on the compressed frequency-domain audio signal.

In step S620 the frequency-domain audio signal is transformed into a first time-domain audio signal. For example, the frequency-domain audio signal can be transformed into a blocked time-domain audio signal. The transform can be, for example, an IDCT, IDFT, IFFT, or the like.

In step S625 a blocking window is obtained. For example, an audio compression/decompression codec (e.g., opus, mp3, ambisonic, AAC, ASF, and the like) can include a windowing function corresponding to the blocking window. Therefore, the blocking window can be obtained (e.g., read from memory) from the codec.

In step S630 the blocking window is modified based on the power coefficient. For example, an initial blocking window can be modified based on a power coefficient to generate a modified blocking window. For example, an amplitude of a windowing function associated with the blocking window can be modified based on the power coefficient.

In step S635 a second time-domain audio signal is generated using the modified blocking window. For example, a reconstructed time-domain audio signal can be generated based on the blocked time-domain audio signal using the modified blocking window. The second time-domain audio signal can be a combination of adjacent blocks of the first time-domain audio signal to generate a continuous output audio signal. The adjacent blocks can be overlap-added. In other words, blocks associated with the first time-domain audio signal can be overlapped in time and concatenated together. The overlapped concatenated audio blocks can then be windowed. Overlapping and windowing the audio blocks can generate smooth transitions (e.g., transitions with minimal noise) between the audio blocks. Windowing can use a windowing function as defined by an audio codec. The blocking window can generate the second time-domain audio signal as a reconstructed audio signal based on the overlap-added and windowed audio blocks.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

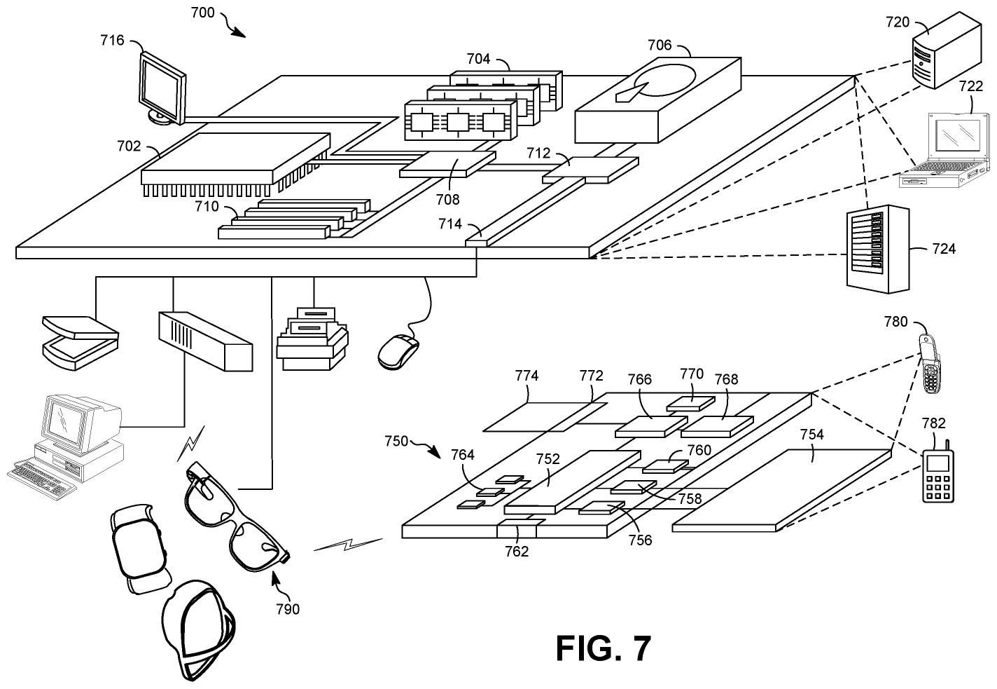

FIG. 7 illustrates an example of a computer device 700 and a mobile computer device 750, which may be used with the techniques described here (e.g., to implement the audio encoder 105 and the audio decoder 130). The computing device 700 includes a processor 702, memory 704, a storage device 706, a high-speed interface 708 connecting to memory 704 and high-speed expansion ports 710, and a low-speed interface 712 connecting to low-speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high-speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer-or machine-readable medium, such as the memory 704, the storage device 706, or memory on processor 702.

The high-speed controller 708 manages bandwidth-intensive operations for the computing device 700, while the low-speed controller 712 manages lower bandwidth-intensive operations. Such allocation of functions is example only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display), and LED (Light Emitting Diode) or an OLED (Organic Light Emitting Diode) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In-Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the figure can include sensors that interface with an AR headset/HMD device 790 to generate an augmented environment for viewing inserted content within the physical space. For example, one or more sensors included on a computing device 750 or other computing device depicted in the figure, can provide input to the AR headset 790 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 750 can use the sensors to determine an absolute position and/or a detected rotation of the computing device in the AR space that can then be used as input to the AR space. For example, the computing device 750 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 750 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 750 when the computing device is incorporated into the AR space can cause a particular action to occur in the AR space.

In some implementations, a touchscreen of the computing device 750 can be rendered as a touchpad in AR space. A user can interact with the touchscreen of the computing device 750. The interactions are rendered, in AR headset 790 for example, as movements on the rendered touchpad in the AR space. The rendered movements can control virtual objects in the AR space.

In some implementations, one or more output devices included on the computing device 750 can provide output and/or feedback to a user of the AR headset 790 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 750 may appear as another object in a computer-generated, 3D environment. Interactions by the user with the computing device 750 (e.g., rotating, shaking, touching a touchscreen, swiping a finger across a touch screen) can be interpreted as interactions with the object in the AR space. In the example of the laser pointer in an AR space, the computing device 750 appears as a virtual laser pointer in the computer-generated, 3D environment. As the user manipulates the computing device 750, the user in the AR space sees movement of the laser pointer. The user receives feedback from interactions with the computing device 750 in the AR environment on the computing device 750 or on the AR headset 790. The user's interactions with the computing device may be translated to interactions with a user interface generated in the AR environment for a controllable device.

In some implementations, a computing device 750 may include a touchscreen. For example, a user can interact with the touchscreen to interact with a user interface for a controllable device. For example, the touchscreen may include user interface elements such as sliders that can control properties of the controllable device.

Computing device 700 is intended to represent various forms of digital computers and devices, including, but not limited to laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

1. A method comprising:
receiving an initial time-domain audio signal;
modifying an initial blocking window, based on a power coefficient, to generate a modified blocking window;
generating a blocked time-domain audio signal using the modified blocking window;
transforming the blocked time-domain audio signal to generate a frequency-domain audio signal; and
compressing the frequency-domain audio signal to generate a compressed frequency-domain audio signal.

2. The method of claim 1, further comprising:
generating a data packet including the compressed frequency-domain audio signal and the power coefficient.

3. The method of claim 1, further comprising:
storing the compressed frequency-domain audio signal and the power coefficient.

4. The method of claim 1, wherein
the modified blocking window is of an encoder,
a decoder blocking window is different from the modified blocking window, and
a product of the modified blocking window with the decoder blocking window at an instance of the modified blocking window is equal to an amplitude of one (1).

5. The method of claim 1, wherein the modifying of the initial blocking window to generate the modified blocking window is (2−pf)*f(t) where pf represents the power coefficient and f(t) represents the initial blocking window.

6. The method of claim 1, wherein
the initial blocking window includes a first portion, a second portion and a third portion, and
modifying the initial blocking window to generate the modified blocking window includes modifying the first portion based on the power coefficient and modifying the third portion based on the power coefficient.

7. The method of claim 1, wherein the power coefficient is generated based on the initial time-domain audio signal.

8. The method of claim 1, wherein the power coefficient is generated based on an entropy associated with the compressing of the frequency-domain audio signal.

9. The method of claim 1, wherein
the power coefficient is generated based on the initial time-domain audio signal, and
the power coefficient is modified based on an entropy associated with the compressing of the frequency-domain audio signal.

10. The method of claim 1, wherein the initial time-domain audio signal is associated with a first timespan, the method further comprising:
detecting a change in the initial time-domain audio signal from the first timespan to a second timespan; and
changing the power coefficient based on the second timespan.

11. The method of claim 1, wherein the blocked time-domain audio signal is a portion of the initial time-domain audio signal over a timespan equal to a timespan associated with the modified blocking window.

12. The method of claim 1, wherein the frequency-domain audio signal includes a frequency content representation of the blocked time-domain audio signal.

13. A method comprising:
receiving a formatted data packet including a compressed frequency-domain audio signal and a power coefficient;
decompressing the compressed frequency-domain audio signal;
transforming the decompressed frequency-domain audio signal into a blocked time-domain audio signal;
modifying an initial blocking window based on a power coefficient to generate a modified blocking window; and
generating a reconstructed time-domain audio signal based on the blocked time-domain audio signal using the modified blocking window.

14. The method of claim 13, further comprising:
playing back the reconstructed time-domain audio signal.

15. The method of claim 13, wherein
the modified blocking window is of a decoder,
an encoder blocking window is different as compared to the modified blocking window, and
a product of the modified blocking window with the encoder blocking window at an instance of the modified blocking window is equal to an amplitude of one (1).

16. The method of claim 13, wherein
the initial blocking window includes a first portion, a second portion and a third portion, and
modifying the initial blocking window to generate the modified blocking window includes modifying the first portion based on the power coefficient and modifying the third portion based on the power coefficient.

17. The method of claim 13, wherein the power coefficient is generated based on an input audio signal corresponding to the reconstructed time-domain audio signal.

18. The method of claim 13, wherein the power coefficient is generated based on an entropy associated with the compressing of the frequency-domain audio signal.

19. The method of claim 13, wherein
the power coefficient is generated based on an input audio signal corresponding to the reconstructed time-domain audio signal, and
the power coefficient is modified based on an entropy associated with the compressing of the frequency-domain audio signal.

20. A non-transitory computer-readable storage medium comprising instructions stored thereon that, when executed by at least one processor, are configured to cause a computing system to:
receive an initial time-domain audio signal;
modify an initial blocking window, based on a power coefficient, to generate a modified blocking window;
generate a blocked time-domain audio signal using the modified blocking window;
transform the blocked time-domain audio signal to generate a frequency-domain audio signal; and
compress the frequency-domain audio signal to generate a compressed frequency-domain audio signal.

21-38. (canceled)
